(19) United States
(12) Patent Application Publication
(10) Pub. No.: US 2007/0220670 A1
(43) Pub. Date: Sep. 27, 2007

(54) Hand Shower

(76) Inventors: Markus Woehrle, Shiltach (DE); Franz Schorn, Schiltach (DE); Ulrich Kienle, Schenkenzell (DE); Helgrid Stoesser, Freudenstadt (DE); Klaus Butzke, Schiltach (DE)

Correspondence Address: DUANE MORRIS, LLP;IP DEPARTMENT, 30 SOUTH 17TH STREET, PHILADELPHIA, PA, 19103-4196, US

(21) Appl. No.: 11/569,466

(22) PCT Filed: May 11, 2005
(86) PCT No.: PCT/EP05/05063

§ 371 Date: Nov. 21, 2006

(30) Foreign Application Priority Data
Jun. 4, 2004 (DE) 10 2004 028 608.6

(51) Int. Cl. A47K 3/28

(52) U.S. Cl. 4/605

(57) ABSTRACT

A hand shower contains a lamp preferably formed by LEDs that emits light through the jet disk, at least when the hand shower is being used. The power is supplied to the lamp from a battery that is in the handle of the hand shower. In a fixed seat, there is a charger that charges the battery in the hand shower when the hand shower is inserted in the seat. To couple the charger to the battery, there is a coupling device that has one coupling element in the seat and one in the hand shower. The coupling device can function with or without contacts.

The invention concerns a hand shower for sanitary purposes.

A water draining fitting is already known (WO 98/28496) where lighting effects are generated in a hand shower. Multicolored light can be emitted from the jet exit disk. The light source for generating this light is at the end of the hose leading to the hand shower. The hand shower contains a fiber-optic conductor that guides the light from the hose to the jet disk. The power is supplied through the hose.

In another shower fixture, a light source is in the shower head that is connected to a voltage source via an electrical line (WO 95/29300).

Special shower hoses must be used for both known devices when the shower fixture is a hand shower.

Furthermore, a shower fixture is known in which LEDs are in the shower head. These are supplied with power by a generator in the shower head that is driven by a turbine (DE 201 01 460).

In another shower fixture (U.S. Pat. No. 6,021,960), the shower head has a seat for a flashlight that emits its light in the middle of the jet disk.

The invention is based on the task of designing a hand shower so that it is suitable to emit light, and it does not require any special feed hoses or other service measures.

To solve this task, the invention proposes a hand shower with the features cited in claim 1. Developments of the invention are the subject matter of the subclaims.

The lamp, i.e. the devices that generate the light, are located in the hand shower itself as proposed by the invention, i.e. not in the hose. To supply the lamps with electricity, there is a battery that is also in the hand shower. To keep this battery continuously operable, a coupling device is provided that can connect the battery to a charger that recharges the battery.

In a development of the invention, the coupling device contains a coupling element that can preferably be in a handle of the hand shower, and logically near the end of the hose connection. The charger also has a coupling element that interacts with the coupling elements of the hand shower.

In a further development of the invention, it can be provided that the hand shower is designed with a holder for a mechanical connection. It is known in hand showers that such are inserted in a special holder after use or while showering. This holder can be designed so that it holds the hand shower in a specific position so that the hand shower can then be used as a body shower or head shower. The holder for example grips the hand shower at a specific place, preferably in the end area of the handle on which the shower hose is screwed.

In a further development, the invention proposes that the hand shower can be designed so that the coupling device is activated when the hand shower is mechanically connected to the holder. When the user places or hangs the hand shower in its holder after use, the coupling device is automatically activated to recharge the battery in the hand shower. This entire process can occur without the user's intervention and even without the user being aware of it. It is of course also possible to design the charger so that it is only fully activated when the coupling device is active. Beforehand, it can be in a standby mode. It is also possible to activate a switch by inserting the hand shower in the holder that then turns on a charger.

The lamp in the hand shower can for example have at least one and preferably a plurality of LEDs. These are suitable to emit light with minimum power consumption. LEDs come in a wide variety of colors so that the color can be a design feature in addition to the light.

For example, LEDs can be in the jet exit surface and directly perceived externally by the user. With a jet exit surface with many small, separate exit nozzles, this can produce a visually appealing appearance.

It is, however, also possible to place the LEDs behind the jet exit disk, for example in the area conducting the water, that shine their light into the water which can then leave the jet exit disk as illuminated water jets. Of course, combinations of both options are feasible.

In a development according to the invention, the battery and possibly other components required to charge the battery can also be in the handle. Since hand showers are used for a relatively short period, small batteries are fully sufficient, and the handle does not have to be enlarged to place the battery in the handle. Sufficient space exists there for a small battery. Since the charging process begins when the hand shower is placed in its holder, and since the hand shower is left in the holder for much longer than the hand shower is used, a small battery will always be sufficiently charged.

The coupling device can for example be inductive as is known in electrically operated toothbrushes. The small currents that arise can also be provided by a coupling device with metal contacts.

Additional features, details and preferences of the invention are found in the claims and the abstract (the wording of which is hereby made part of the description by means of reference), the following description of a preferred embodiment of the invention, and the drawing.

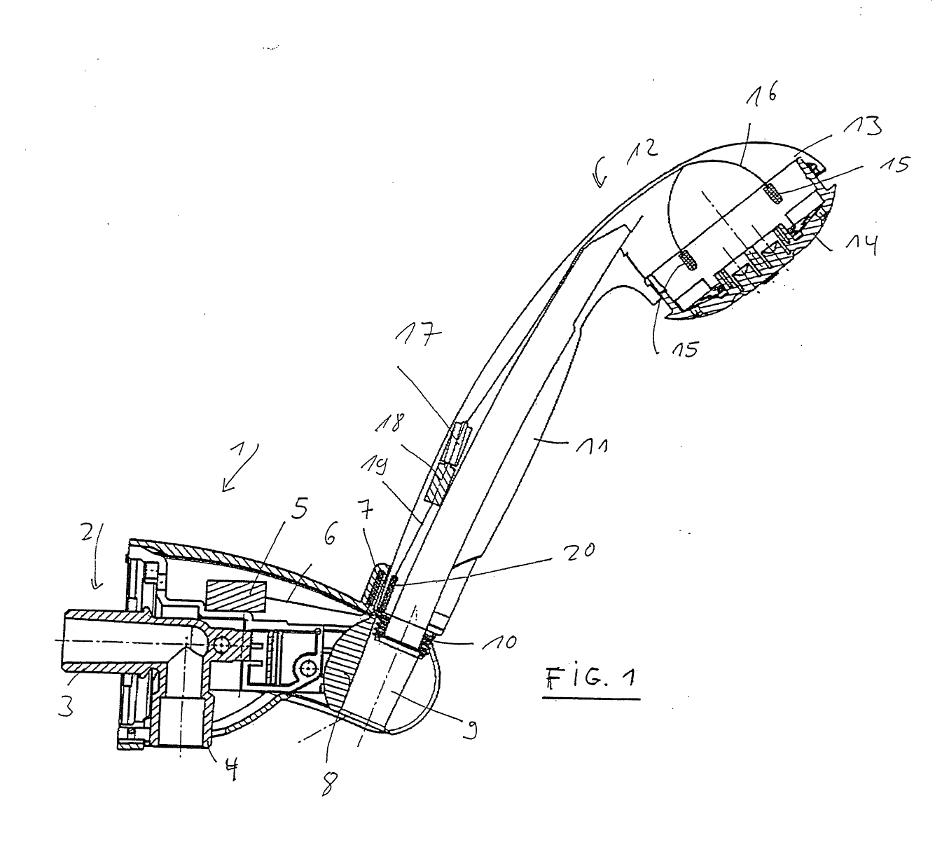

FIG. 1 shows a schematic section of a hand shower without a shower hose inserted in a shower holder;

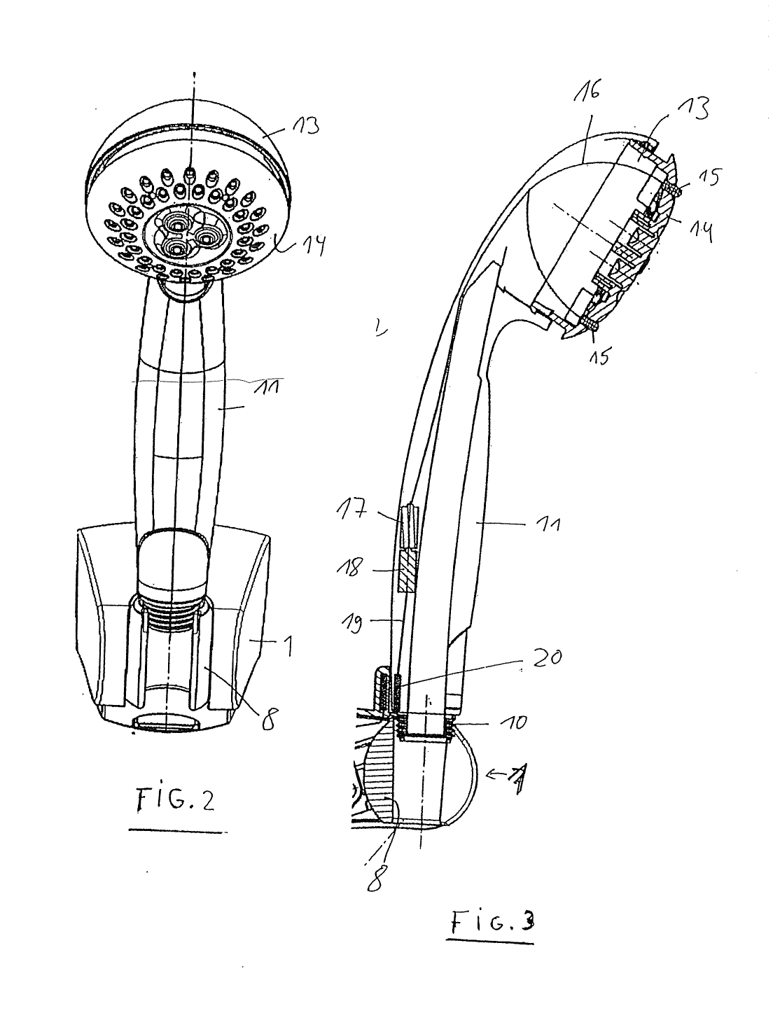

FIG. 2 shows a view of the shower in FIG. 1 from the right side in FIG. 1;

FIG. 3 shows a schematic section corresponding to FIG. 1 of a hand shower in a second embodiment of the invention.

The hand shower depicted in FIG. I is inserted in a holder 1 when it is not used. The holder 1 contains a connecting elbow 2 that is screwed into a water line of the house plumbing system with its horizontal leg 3. The leg 4 generally extending downward at a right angle from this leg 3 is for screwing into one end of a shower hose. The holder is affixed to the wall with devices (not shown). The holder contains a transformer 5 that has a power supply, for example the house electrical system. Via a line 6 that is only schematically represented, the transformer 5 is connected to a coupling element 7 of a coupling device. Details of such coupling devices are generally known and will therefore not be further explained in this context. The transformer 5 and the line 6 leading to the coupling element 7 form a charging device in the depicted embodiment.

The transformer can of course also be located outside of the holder at any location in the building. Then the line leading to the coupling element forms the charging device.

Inserted in the front end of the holder 1 is a conical seat 8 that can be swung at a given angle on a horizontal axis. In the portrayed position, the conical holder 8 has reached its end position. In the passage 9 in the conical holder 8 that is open at the front, a union nut is normally held on the end of the shower hose that is screwed onto the thread 10 of the handle 11 of the hand shower. This is not shown in this instance for reasons of simplification.

The hand shower 12 schematically portrayed here has a handle 11 whose end assigned to the shower hose is inserted in the holder 1. On the opposite end, the hand shower 12 transitions into a shower head 13 that has a jet disk 14 at the front. Different types of water jets exit the jet disk 14 through the available openings. The front surface of the jet disk 14 forms a jet exit surface.

Lamps are inside the shower head 13, such as a plurality of LEDs 15 of which only two are portrayed in FIG. 1. These are connected via schematically illustrated lines 16 to a battery 17 that is in the handle 11. The battery 17 is connected via a rectifier 18 and a line 19 to a coupling element 20 that is located in the end of the handle 11 such that it can interact with the coupling element 7 in the holder 1. The two coupling elements 7, 20 jointly form a coupling device by means of which power can be fed to the battery 17 as long as the hand shower is inserted in the holder.

The two LEDs 15 are located in the area behind the jet disk 14. This area is designed so that water can flow through it to the openings of the jet disk 14. The LEDs are located directly behind corresponding jet exit openings so that the water jets are illuminated from the inside. Due to total reflection, the light is transmitted into these water jets as long as they exit the jet exit disk 4 as coherent water jets. When showering, the user sees illuminated water jets that can have different colors depending on the type of LEDs.

FIG. 2 shows the hand shower 12 inserted in the holder 1 from the front. The shower hose is again omitted. The jet exit disk does not differ from a conventional jet exit disk since the LEDs are inside the housing, and the housing also does not differ from a conventional hand shower.

Whereas the lamps in the embodiment in FIG. 1 that are formed by the LEDs 15 are only discernible on the outside by their effect, FIG. 3 shows an embodiment in which the LEDs 15 are placed directly in the jet exit disk 14. They can therefore be seen directly.

Of course it is also possible to place lamps in the jet disk 14 that are directly visible and also inside the shower head so that they are only discernible by their effect.

The lamps formed by the LEDs in the portrayed exemplary embodiment can for example be continuously supplied with voltage so that they always shine. If the hand shower is in the holder, it receives its power from the charger that is formed by the transformer 5 and the lines 6. If the hand shower is removed from the holder to inactivate the coupling device, they receive their power from the battery 17 in the handle. As soon as the user reinserts the hand shower in the provided holder, the battery is recharged without the user having to do anything special. The user does not even have to be aware that a charging process is occurring.

It is also possible and lies within the scope of the invention to always turn off the lamps when the charger is active. Whenever the hand shower is inserted into the holder, electronics in the hand shower can turn off the lamps. The electronics can for example recognize this state by the fact that a charging processes occurring.

The lamps are preferably turned on when the hand shower is being used, i.e., removed from the holder.

Switches that are actuated manually or by the flow of the water can also be provided.

What is claimed is:

1. A hand shower, comprising:
a shower head that has a jet exit surface,
a lamp in the shower head,
a battery to operate the lamp, and
a coupling device to couple the battery to a charger.

2. The hand shower according to claim 1, wherein the coupling device is on a hose connection end of a handle at which the hand shower is connectable to a hose.

3. The hand shower according to claim 1, wherein the hand shower is designed to be mechanically connectable with a holder and removable from the holder.

4. The hand shower according to claim 3, wherein the hand shower is designed so that the coupling device is activated when the hand shower is mechanically connected to the holder.

5. The hand shower according to claim 1, wherein the lamp comprises a plurality of LEDs.

6. The hand shower according to claim 5, wherein the LEDs are in a jet disk defining the jet exit surface and are visible from outside of the hand shower.

7. The hand shower according to claim 5, wherein the LEDs are behind a jet exit disk defining the jet exit surface and transmit light into water jets from the let exit disk.

8. The hand shower according to claim 1, further comprising a handle at which the hand shower is coupleable to a hose, wherein the battery is located in the handle and wherein the coupling device charges the battery from a holder when the handle is placed in the holder.

9. The hand shower according to claim 8, wherein the coupling device functions inductively.

10. The hand shower according to claim 8, wherein the coupling device functions with contacts.

11. The hand shower according to claim 3, wherein the holder comprises a wall holder with a connection for a shower hose leading to the hand shower.

12. The hand shower according to claim 3, comprising a connection for the charger in the holder.

13. The hand shower according to claim 3, comprising a transformer located in the holder as a part of the charger.
